(19) United States
(12) Patent Application Publication
(10) Pub. No.: US 2016/0377450 A1
(43) Pub. Date: Dec. 29, 2016

(54) PEDOMETER SYSTEM

(71) Applicant: Great Giant Fibre Garment Co., Ltd., Taipei City (TW)

(72) Inventor: Kung-Jen HSU, Taipei City (TW)

(21) Appl. No.: 14/795,970

(22) Filed: Jul. 10, 2015

(30) Foreign Application Priority Data
Jun. 26, 2015 (TW) 104120845

(51) Int. Cl. G01C 22/00

(52) U.S. Cl. CPC G01C 22/006

(57) ABSTRACT

A pedometer system comprises a pedometer and a portable electronic device. The pedometer is located on a garment and comprises a sensor, a battery, a first transmission unit and a microcontroller. The sensor senses a number of completed paces of a user which walks or runs. The portable electronic device comprises a second transmission unit, a display screen, a processor and a storage device. The storage device is connected to the processor and stores a pedometer application program which has a number of target paces. When the number of completed paces greater than the number of target paces, the pedometer application program displays a preferential certificate by the display screen. Through the pedometer system, the present invention can increase motive of using pedometer regularly, then accomplish the purpose of maintaining health.

### CROSS-REFERENCE TO RELATED APPLICATION

This application claims priority of application No. 104120845, filed on Jun. 26, 2015 in the Taiwan Intellectual Property Office.

### FIELD OF THE INVENTION

The invention relates to pedometer system, and more particularly to a pedometer which is located on a garment, is connected to a portable electronic device and achieves a number of target paces to gain a preferential certificate for increasing motive of using pedometer regularly.

### BACKGROUND OF THE INVENTION

A pedometer is an electronic device, which is worn on a user's body for sensing the user's walking paces or running paces. The pedometer can accumulate the user's walking paces or running paces during a particular period of time. As the pedometer accumulates the user's walking paces or running paces, the user can comprehend walking information or running information clearly at any time.

The pedometer except accumulates the user's walking paces or running paces, a new type of the pedometer can calculate a number of burned calories by inputting the user's weight and combining an accumulated number of the user's walking paces or running paces. If the user walks or runs for one hour, and the user burns 300 kilocalories which is calculated by the pedometer. The user can set a target of reducing weight according to the calculation of the pedometer.

Besides, a pedometer combines a portable electronic device, which is invented by a manufacturer. The above pedometer can store each day's paces by the storage device of the second transmission unit. So the above pedometer can observe long-term accumulative activity information and can set a number of target paces for each day or each week. With reference to Taiwan patent No. 201300738, a pedometer system and a pedometer with data transmission function are disclosed. The pedometer system comprises a pedometer and a portable terminal. The pedometer comprises a controller and a first transmission unit. The portable terminal a second transmission unit, a processor and a display screen. The pedometer and the portable terminal transmit data each other by the first transmission unit and the second transmission unit. The controller gets a number of pace that is recorded by the pedometer in real time, and transmits the number of pace to the processor. The processor displays the number of pace by the display screen.

With reference to Taiwan patent No. M360357, a pedometer combining footwear is disclosed. The pedometer comprises a shoe structure, a pedometer and a display unit. A sole of the shoe structure comprises a space. A perspective part is located on the bottom of the space and is made from transparent material or forms a hollow gap. The pedometer is located in the space of the shoe structure and comprises a light source and a receiving terminal. The display unit comprises a display surface and is connected to the pedometer. Through above structure, the present utility can increase sensitivity by optical character, which can avoid counting loss from high speed walking or running. The present utility does not have any physical collision and abrasion, which can increase durability.

With reference to Taiwan patent No. M376870, a pedometer combining multimedia device is disclosed. The pedometer comprises a MP4 player and is used for a user can listen music in sport conveniently. Through the MP4 player, the user can enjoy MP4 while take a break after an athleticism. The pedometer comprises a main structure. A hollow space is concave located in the main structure. A storage device is located in the hollow space. A circuit board main structure of one end of the storage device is located in the hollow space of the main structure. Another end of storage device is a USB connector and is protrude and reveals the main structure for connecting a computer. A protective cover is located on the USB connector, which can combine and separate with the main structure for covering and hiding the USB connector. So a user can open the protective cover to let the USB connector is connected to a computer which the user want to store data in. Then the MP4 player downloads data to make digital data is stored in the pedometer. Accordingly, when the user uses the pedometer, the user can carry the digital data which is store in the pedometer to decrease probability of missing data. Which kind of the above pedometers are, all of the above pedometers comprehend body's activity information from accumulating the number of paces. However, all of the above pedometers does not have any funny added value except user's perseverance, which cannot increase motive of using pedometer regularly nor accomplish the purpose of maintaining health. Even though these disadvantages of the prior art are known, there have been no acceptable and easy solutions to solve the problem. The applicant is a professional garment manufacturer, which has an idea of combining a pedometer and a garment. The idea not only can give the garment funny and vivid feature, but also enhances the garment's added value, which further increase motive of using pedometer regularly nor accomplish the purpose of maintaining health.

### SUMMARY OF THE INVENTION

One objective of the invention is to provide a pedometer system. In one embodiment, the pedometer system comprises a pedometer and a portable electronic device. The pedometer is located on a garment and comprises a sensor, a battery, a first transmission unit and a microcontroller. The sensor senses a number of completed paces of a user which walks or runs. The battery provides a power. The first transmission unit gets and transmits the number of completed paces. The microcontroller is connected to the sensor, the battery and the first transmission unit, which controls the first transmission unit to get and to transmit the number of completed paces.

The portable electronic device comprises a second transmission unit, a display screen, a processor and a storage device. The second transmission unit is connected to the first transmission unit and receives the number of completed paces which is transmitted by the first transmission unit. The processor is connected to the second transmission unit and the display screen, gets the number of completed paces and displays the number of completed paces by the display screen. The storage device is connected to the processor and stores a pedometer application program which has a number of target paces. When the number of completed paces greater than the number of target paces, the pedometer application program displays a preferential certificate by the display screen.

In one preferential embodiment, the pedometer further comprises a debugger. The debugger is connected to the microcontroller and debugs the number of completed paces.

In one preferential embodiment, the second transmission unit is connected to the first transmission unit by a wire communication.

In one preferential embodiment, the second transmission unit is connected to the first transmission unit by a wireless communication.

In one preferential embodiment, the wireless communication is Bluetooth.

In one preferential embodiment, the wireless communication is Near Field Communication (NFC).

In one preferential embodiment, the preferential certificate is Quick Response Code (QR code) or barcode.

When the number of completed paces greater than the number of target paces, the pedometer application program displays a preferential certificate by the display screen. So the present invention can increase motive of using pedometer regularly, then accomplish the purpose of maintaining health.

### BRIEF DESCRIPTION OF THE DRAWINGS

FIG. 1 is a first perspective view showing one preferential embodiment of the pedometer system of the present invention;

FIG. 2 is a second perspective view showing one preferential embodiment of the pedometer system of the present invention;

FIG. 3 is a block diagram showing one preferential embodiment of the pedometer system of the present invention;

FIG. 4 is a third perspective view showing one preferential embodiment of the pedometer system of the present invention;

FIG. 5 is a fourth perspective view showing one preferential embodiment of the pedometer system of the present invention;

FIG. 6 is a fifth perspective view showing one preferential embodiment of the pedometer system of the present invention;

FIG. 7 is a sixth perspective view showing one preferential embodiment of the pedometer system of the present invention;

FIG. 8 is a seventh perspective view showing one preferential embodiment of the pedometer system of the present invention;

FIG. 9 is a eighth perspective view showing one preferential embodiment of the pedometer system of the present invention; and

FIG. 10 is a ninth perspective view showing one preferential embodiment of the pedometer system of the present invention.

### DETAILED DESCRIPTION OF THE INVENTION

In order to describe details of the preferred embodiment of the present invention, description of the structure, and the application as well as the steps are made with reference to the accompanying drawings. It is learned that after the description, any variation, modification or the like to the structure and the steps of the embodiments of the preferred embodiment of the present invention is easily made available to any person skilled in the art. Thus, the following description is only for illustrative purpose only and does not, in any way, try to limit the scope of the present invention.

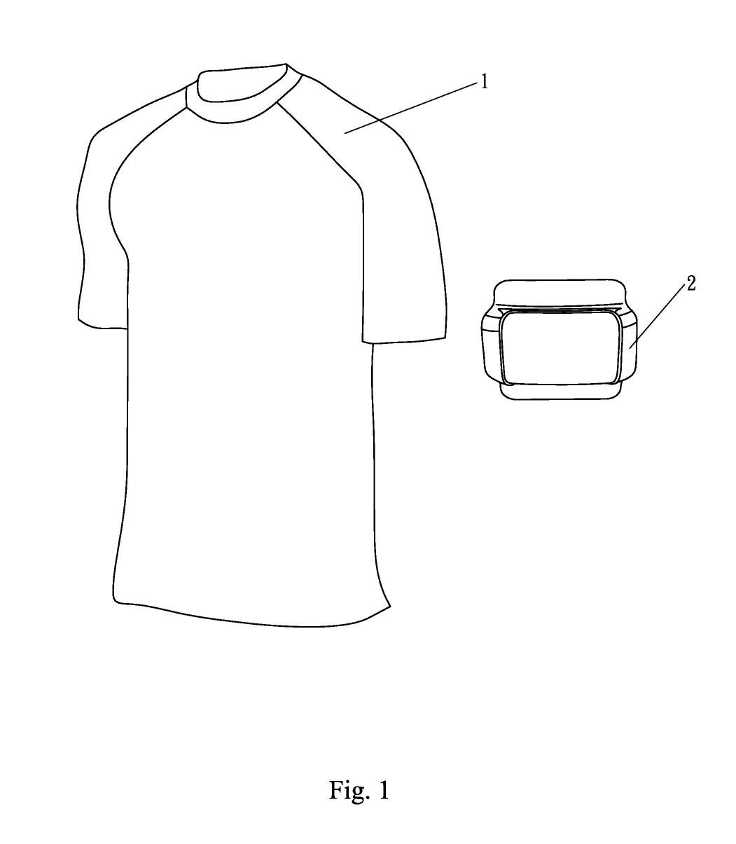

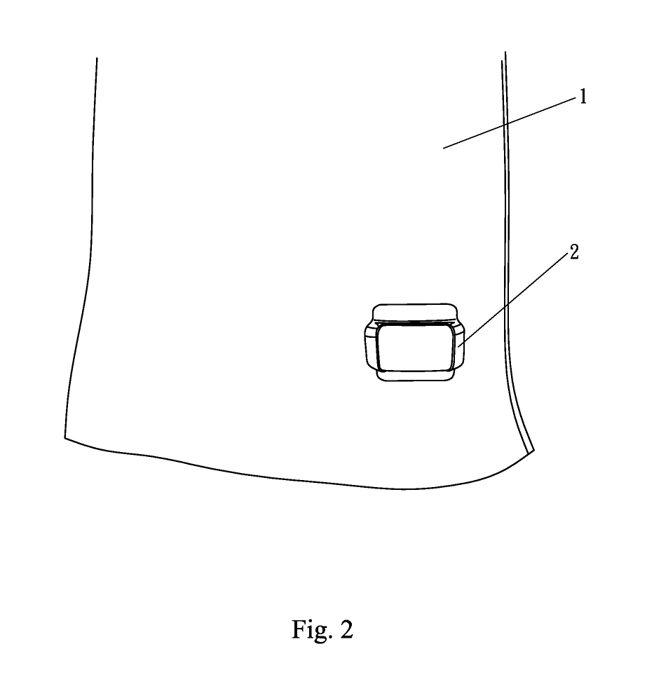

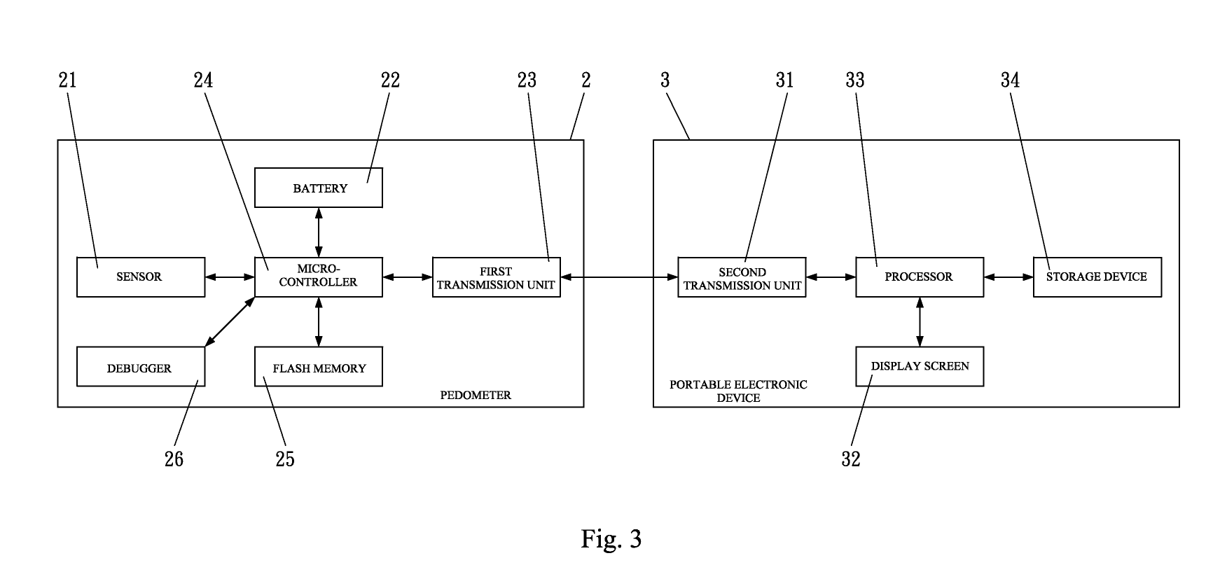

With reference to FIGS. 1, 2 and 3 of the preferred embodiment of the present invention, a pedometer system constructed in accordance with the present invention is a pedometer 2 that is located on a garment 1 and is connected to a portable electronic device 3. The garment 1 not only is a cover for human trunk and limbs, but also a cover for hand (glove), foot (hose) and head (hat). In present embodiment, the pedometer 2 is located on a garment 1 by machine sewing. But other way or other position is also feasible. The pedometer system in accordance with the present invention through makes a number of completed paces greater than a number of target paces to get a preferential certificate, so the present invention can increase motive of using pedometer regularly. The pedometer system in accordance with the present invention comprises a pedometer 2 and a portable electronic device 3.

The pedometer 2 is located on a garment 1 and comprises a sensor 21, a battery 22, a first transmission unit 23 and a microcontroller 24.

The sensor 21 senses a number of completed paces of a user which walks or runs. For example, the sensor 21 is a g-sensor or an accelerometer, which can offer information about velocity or displacement. The sensor 21 of the present invention is a g-sensor to sense a number of completed paces of a user who walks or runs, which counts a number of completed paces of a user according to the information about velocity or displacement when the user is walking or running

The battery 22 provides a power. For example, the battery 22 is a lithium battery.

The first transmission unit 23 gets and transmits the number of completed paces.

The microcontroller 24 is connected to the sensor 21, the battery 22 and the first transmission unit 23, which controls the first transmission unit 23 to get and to transmit the number of completed paces. For example, the microcontroller 24 comprises a peripheral which is static random access memory/random access memory or output/input interface. Moreover, the microcontroller 24 further is connected to a flash memory 25 (Flash). For example, the microcontroller 24 is connected to the flash memory 25 by a serial peripheral interface bus (SPI). In the present specification, the serial peripheral interface bus is four-wire synchronous data protocol. The microcontroller 24 is a master of the serial peripheral interface. The flash memory 25 is a slave of the serial peripheral interface.

Moreover, the pedometer 2 further comprises a debugger 26. The debugger 26 is connected to the microcontroller 24 and debugs the number of completed paces. In other words, the debugger 26 debugs the number of completed paces that is got by the microcontroller 24. If the sensor 21 senses the user's walking or running velocity greater or smaller than a preset velocity or a preset displacement, the debugger 26 cannot judge the number of completed paces is valid number of completed paces, then debugs the number of completed paces.

The portable electronic device 3 is a smart phone or a tablet personal computer and so forth, which adopts Android or iPhone operating system and so forth. The portable electronic device 3 comprises a second transmission unit 31, a display screen 32, a processor 33 and a storage device 34.

The second transmission unit 31 is connected to the first transmission unit 23 and receives the number of completed paces which is transmitted by the first transmission unit 23. Wherein, the second transmission unit 31 is connected to the first transmission unit 23 by a wire communication or a wireless communication. If the second transmission unit 31 is connected to the first transmission unit 23 by a wire communication, the wire communication communicates by wire. If the second transmission unit 31 is connected to the first transmission unit 23 by a wireless communication, the wireless communication is Bluetooth or Near Field Communication (NFC) and so forth.

The processor 33 is connected to the second transmission unit 31 and the display screen 32, gets the number of completed paces and displays the number of completed paces by the display screen 32. For example, the processor 33 can process the number of completed paces to a number of cumulative completed paces about user walks or runs, and displays the number of cumulative completed paces on the display screen 32.

The storage device 34 is connected to the processor 33 and stores a pedometer application program. The pedometer application program in the present specification is mobile application, which is also known as mobile app or app. The mobile app is an application program designed to run on mobile devices such as smartphones, tablet computers and other portable electronic device. The user can download the mobile app in an app Store through internet. Some mobile apps are free, while others must be bought.

The pedometer application program which has a number of target paces which can be preset or be got from other user's number of completed paces through internet.

When the number of completed paces greater than the number of target paces, the pedometer application program displays a preferential certificate by the display screen 32. For example, the preferential certificate is Quick Response Code (QR code) or barcode and so forth.

With reference to above structure and composition design, one preferential embodiment of the present invention is described below: When the user uses the pedometer system in accordance with the present invention, because the pedometer 2 is located on a garment 1, so the user can put on the garment 1 in the beginning of a day and wear on the pedometer 2 on the body in the same time. Then, the user can hold the portable electronic device 3 and execute the pedometer application program. When the pedometer application program is executed, the pedometer application program would be connected to the pedometer 2 by the second transmission unit 31. At this time, the number of completed paces about the user walking or running can be counted by the pedometer 2.

The user can display the number of cumulative completed paces by the portable electronic device 3 after all day's walking or running If the number of target paces is be set as the biggest number among other user's numbers of cumulative completed paces, so if the number of completed paces greater than the number of target paces, in other words, the number of completed paces of the user is No. 1 among all user's numbers of cumulative completed paces, then the pedometer application program can display a preferential certificate by the display screen 32. For example, the preferential certificate is a garment preferential certificate, the user can buy a garment with a preferential price in a shop by the preferential certificate.

Additionally, because the pedometer 2 is connected to the flash memory 25, so when the pedometer 2 senses a number of completed paces about the user walking or running, the pedometer 2 can save the number of completed paces in the flash memory 25 in advance. When the pedometer 2 is connected to the portable electronic device 3, the pedometer 2 transmits the number of completed paces to the portable electronic device 3 afterward.

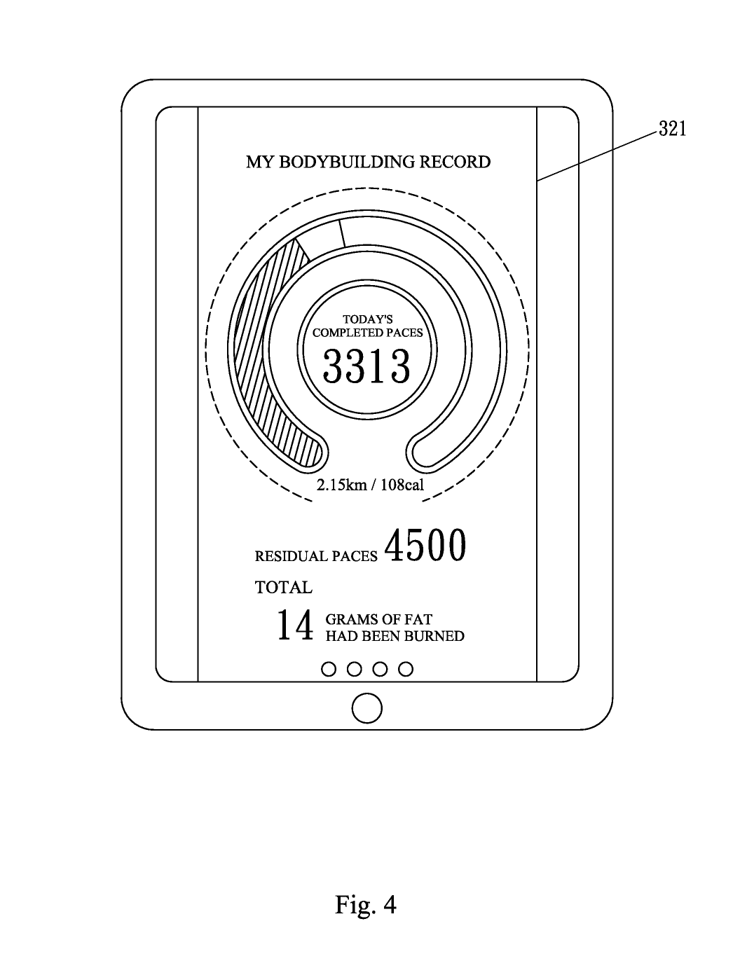

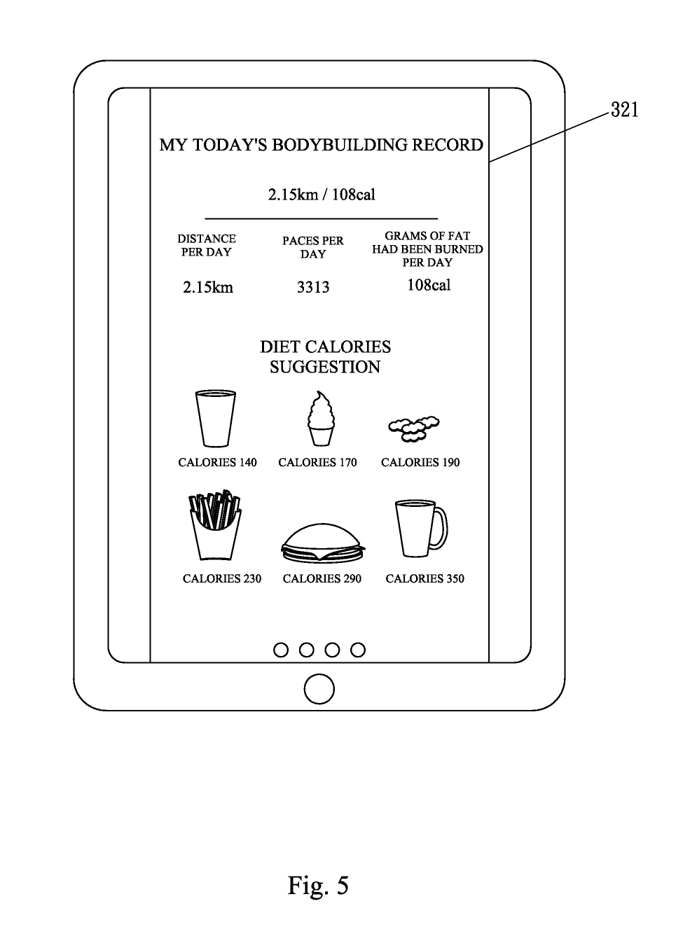

Moreover, the pedometer application program in accordance with the present invention comprises a display interface, a competition interface, a user interface, a recording interface and a preferential certificate. With reference to FIGS. 4 and 5, the pedometer application program comprises a display interface 321. The display interface 321 displays the number of completed paces and related information thereof by the display screen 32. With reference to FIG. 4, the display interface 321 is “MY BODYBUILDING RECORD” which displays the number of completed paces is 3313 paces, a counted walking distance or counted running distance is 2.15 kilometers, a counted number of burned calories is 108 calories, a number of residual paces is 4500 paces, and a counted number of total fat had been burned is 14 grams. With reference to FIG. 5, the display interface 321 is “MY TODAY'S BODYBUILDING RECORD” which displays a number of today's completed paces is 3313 paces, a counted walking distance or counted running distance is 2.15 kilometers, a counted number of burned calories is 108 calories, diet calories suggestion and so forth.

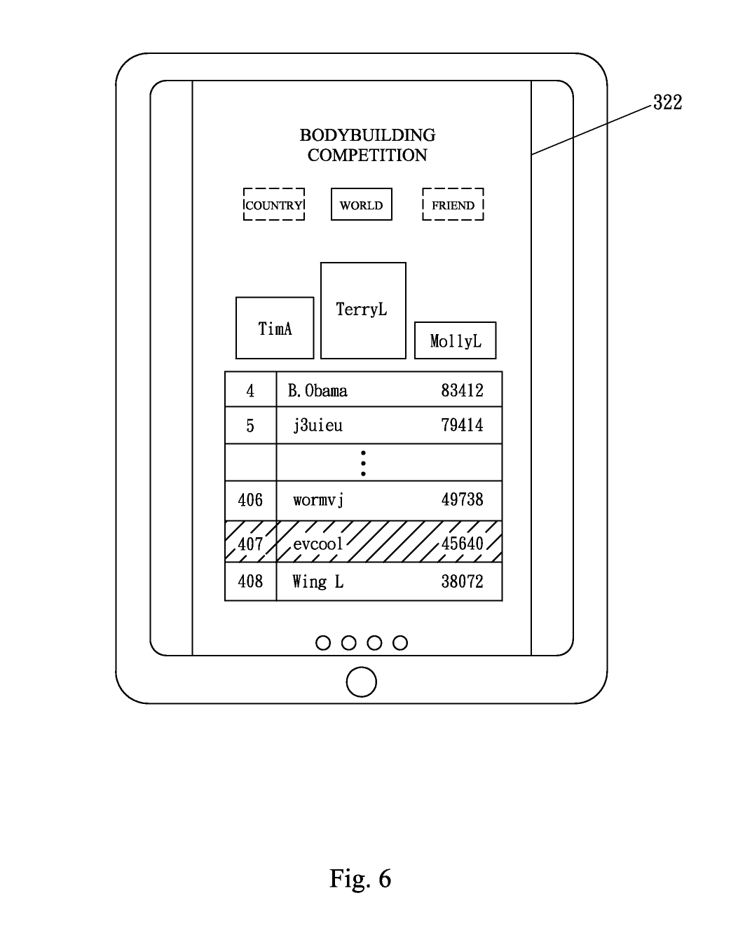

With reference to FIG. 6, the pedometer application program comprises a competition interface 322. The competition interface 322 displays the user's number of completed paces by the display screen 32. Moreover, the portable electronic device 3 can get other user's number of completed paces through internet. The competition interface 322 is “BODYBUILDING COMPETITION” which classifies to a country competition, a world competition and a friend competition. The competition interface 322 can proceed the world competition with other user's number of completed paces. In one embodiment, the user's number of completed pace is ranked No. 407.

For example, the pedometer system in accordance with the present invention comprises a cloud platform. Multiple portable electronic devices 3 are connected to the cloud platform. The cloud platform collects multiple user data and multiple numbers of completed paces from multiple portable electronic devices 3, then the cloud platform proceeds the country competition, the world competition and the friend competition according to the multiple numbers of completed paces.

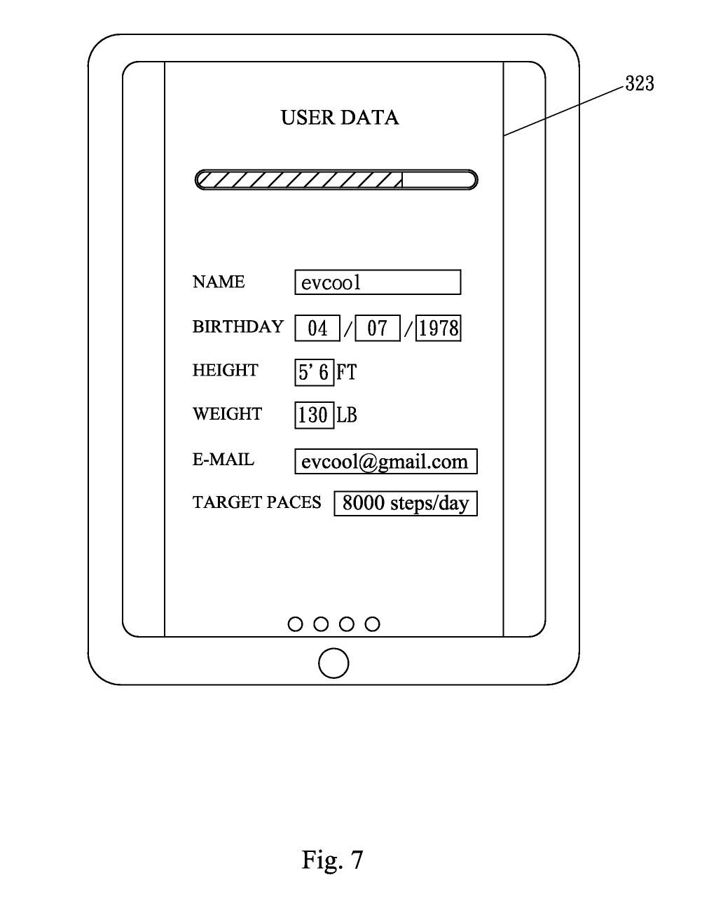

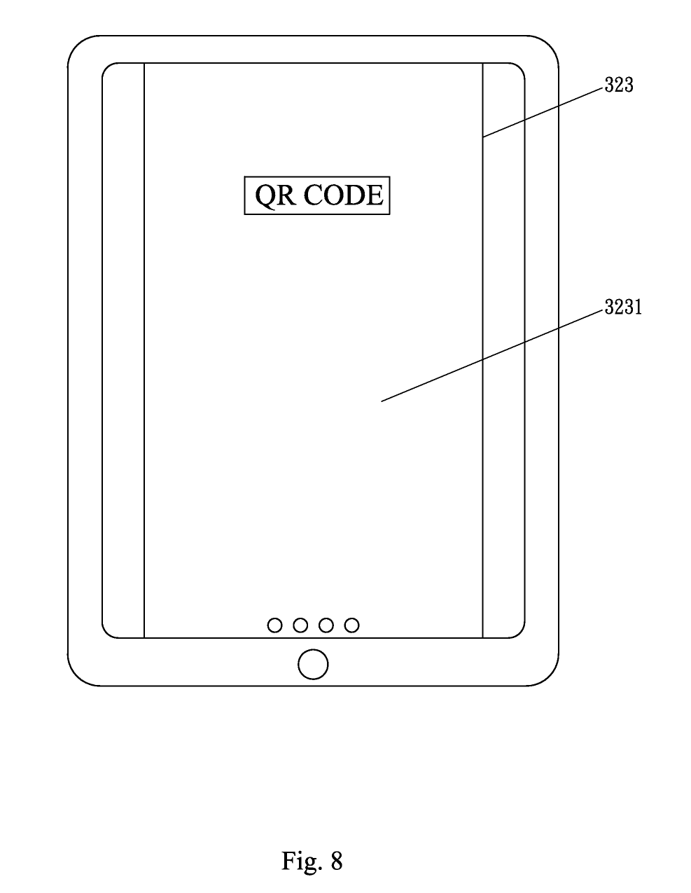

With reference to FIGS. 7 and 8, the pedometer application program comprises a user interface 323. The user interface 323 displays user data and the preferential certificate 3231. With reference to FIG. 7, the user interface 323 is “USER DATA”, which is inputted user name, birthday, height, weight and E-Mail and displays the number of target paces. With reference to FIG. 8, when the user's number of completed paces is greater than the number of target paces, the pedometer application program displays a preferential certificate 3231 by the display screen 32. For example, the preferential certificate 3231 is Quick Response Code or barcode. Wherein, the number of target paces can be preset by the pedometer application program or is the biggest number among the other user's numbers of completed paces. The user can use the preferential certificate 3231 to exchange discount in store. For example, the user can use the preferential certificate 3231 to a store which has a point of sale system. The point of sale system comprises an input device. The input device is Quick Response Code input device or barcode input device, which reads the preferential certificate 3231. So the user can use the preferential certificate 3231 to exchange a coffee for free or with a discount.

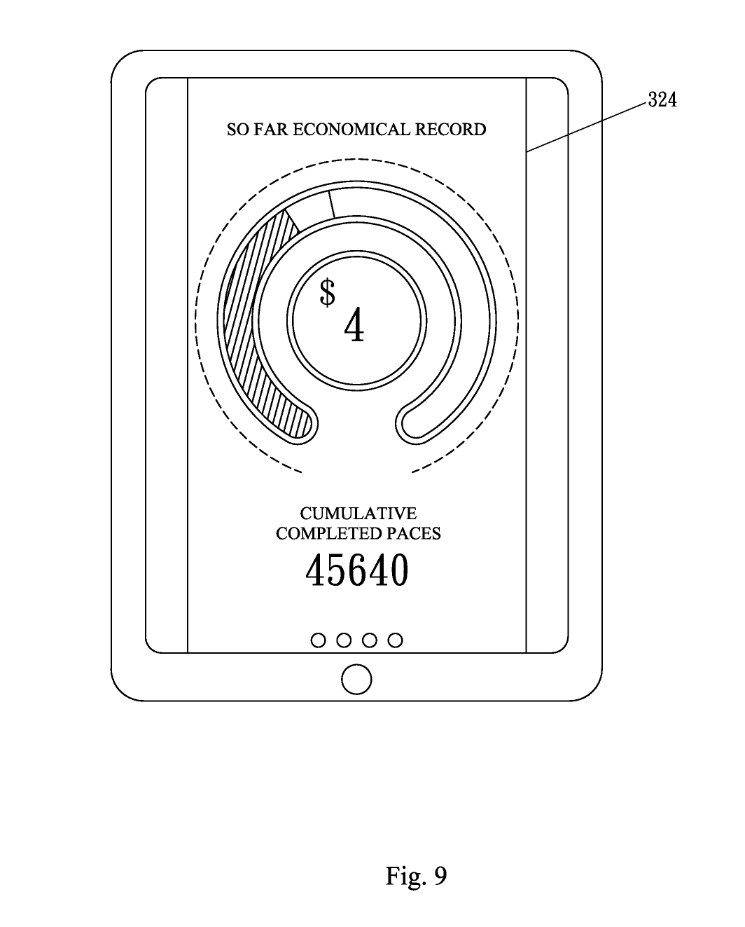

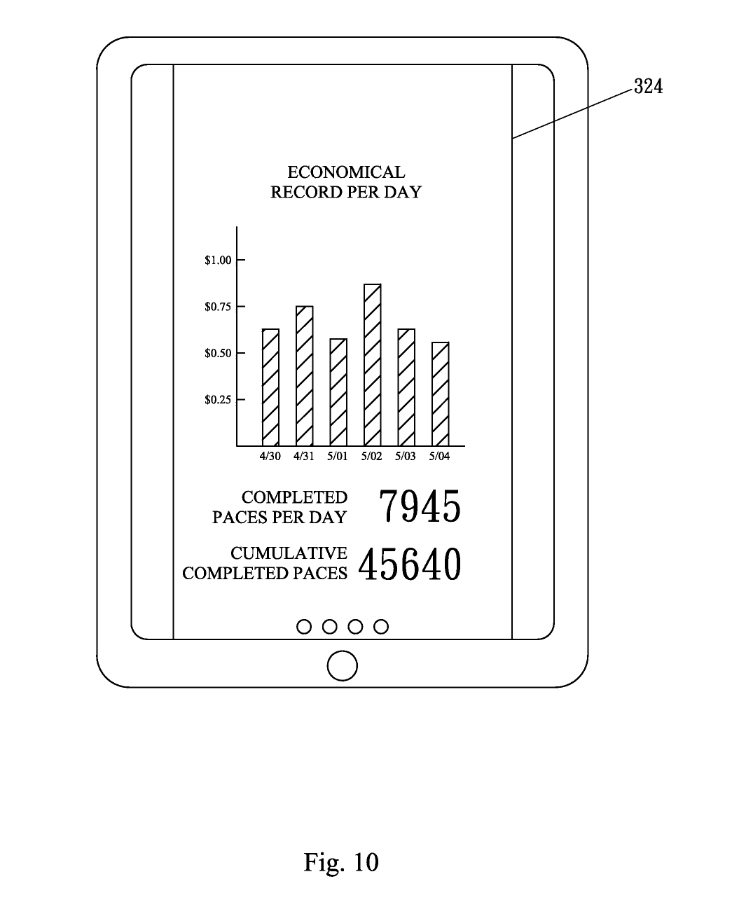

With reference to FIGS. 9 and 10, the pedometer application program comprises a recording interface 324. The recording interface 324 records the user's the number of completed paces and the corresponding preferential merit which has been gotten. With reference to FIG. 9, the recording interface 324 is “SO FAR ECONOMICAL RECORD”. The user's numbers of cumulative completed paces is 45640 paces. The recording interface 324 counts an economical expense is 4 dollars according to how many times the user's the number of completed paces greater than the number of target paces. With reference to FIG. 10, the recording interface 324 is “ECONOMICAL RECORD PER DAY”. The user's completed paces per day is 7954 paces, the numbers of cumulative completed paces is 45640 paces. The recording interface 324 records economical expense per day and is displayed for the user.

Additionally, after the user uses the preferential certificate 3231, the pedometer application program should renew the numbers of cumulative completed paces to get the preferential certificate 3231. The pedometer application program can reset the economical expense to zero for inspiring the user aims the number of target paces to get the preferential certificate 3231.

Hence, reference to FIGS. 1 and 10, the pedometer system in accordance with the present invention compares to prior art with following advantages: Each pace of the user can be accumulated to exchange discount (the preferential certificate 3231) for saving expense in next shopping time. So the pedometer system in accordance with the present invention can increase motive of using pedometer regularly, then accomplish the purpose of maintaining health.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A pedometer system comprising:
a pedometer being located on a garment and comprising:
a sensor sensing a number of completed paces of a user which walking or running;
a battery providing a power;
a first transmission unit getting and transmitting the number of completed paces; and
a microcontroller being connected to the sensor, the battery and the first transmission unit and controlling the first transmission unit to get and to transmit the number of completed paces; and
a portable electronic device comprising:
a second transmission unit being connected to the first transmission unit and receiving the number of completed paces which being transmitted by the first transmission unit;
a display screen;
a processor being connected to the second transmission unit and the display screen, getting the number of completed paces and displaying the number of completed paces by the display screen; and
a storage device being connected to the processor and storing a pedometer application program which having a number of target paces, when the number of completed paces greater than the number of target paces, the pedometer application program displaying a preferential certificate by the display screen.

2. The pedometer system as claimed in claim 1, wherein the pedometer further comprises a debugger, the debugger is connected to the microcontroller and debugs the number of completed paces.

3. The pedometer system as claimed in claim 1, wherein the second transmission unit is connected to the first transmission unit by a wire communication.

4. The pedometer system as claimed in claim 1, wherein the second transmission unit is connected to the first transmission unit by a wireless communication.

5. The pedometer system as claimed in claim 4, wherein the wireless communication is Bluetooth.

6. The pedometer system as claimed in claim 4, wherein the wireless communication is Near Field Communication (NFC).

7. The pedometer system as claimed in claim 4, wherein the preferential certificate is Quick Response Code (QR code).

8. The pedometer system as claimed in claim 4, wherein the preferential certificate is barcode.
